(19) United States
(12) Patent Application Publication
(10) Pub. No.: US 2014/0056427 A1
(43) Pub. Date: Feb. 27, 2014

(54) APPARATUS AND METHOD FOR PROVIDING SECURE COMMUNICATIONS IN A NETWORK

(71) Applicant: GE INTELLIGENT PLATFORMS, INC, Charlottesville, VA (US)

(72) Inventors: Gregory DUNN, Vancouver (CA); Kenneth DICKIE, Edmonton (CA)

(73) Assignee: GE INTELLIGENT PLATFORMS, INC., Charlottesville, VA (US)

(21) Appl. No.: 13/760,748

(22) Filed: Feb. 6, 2013

Related U.S. Application Data
(60) Provisional application No. 61/691,293, filed on Aug. 21, 2012.

(51) Int. Cl. H04L 9/00

(52) U.S. Cl. CPC H04L 9/00
USPC 380/255

(57) ABSTRACT

A secure communication channel is established between the communication network and a first automation controller. The first automation controller is located remotely from the communication network. First data is transmitted between the communication network and the first automation controller or second data is transmitted between the first automation controller and the communication network utilizing the secure communication channel. At the communication network, automatically performing a function relating to the first automation controller using and in response to receiving the second data.

### CROSS REFERENCES TO RELATED APPLICATIONS

Utility application entitled “Creating and Integrating Control Logic” naming as inventor Kenneth Dickie and having attorney docket number 262587 (102672); and

Utility application entitled “Apparatus and Method for the Deployment and Monitoring of Control Logic” naming as inventor Kenneth Dickie and having attorney docket number 262588 (102673), both of which are being filed on the same day as the present application and the contents of both of which are incorporated herein by reference in their entireties.

This application claims benefit under 35 U.S.C. §119 (e) to U.S. Provisional Application No. 61/691,293 entitled “Solution Configurator in a Cloud-based System” filed Aug. 21, 2012, the content of which is incorporated herein by reference in its entirety.

### BACKGROUND OF THE INVENTION

1. Field of the Invention

The subject matter disclosed herein relates to providing communications between automation controllers, and, more specifically, to ensuring that these communications are secure.

2. Brief Description of the Related Art

Automated devices perform various functions and these devices typically include a controller or control device that controls or manages the execution of these functions. For example, robotic controllers (e.g., those that utilize microprocessors) often control the functions of a robot and the robot can perform various manufacturing tasks. Assembly line controllers are used to control the various functions performed on or at an assembly line. A consumer device controller may be used to control the operation and functioning of any type of consumer device (e.g., security system, lighting system, heating system, traffic light or pump control). Together, these types of controllers provide automated functions and are generally referred to as automation controllers.

An automation controller typically includes and utilizes control logic to perform its functions. Control logic solutions may include computer software and/or computer hardware that performs various predetermined functions. For example, an assembly line controller (e.g., for a bottling plant) may include a microprocessor that operates programmed computer software to regulate the speed and other functions associated with operating an assembly line that fills and caps the bottles. In another example, a controller may also include a microprocessor running programmed computer software that regulates various device parameters (e.g., temperature, pressure, or operating speed). In yet another example, a water system controller may include control logic that controls pumps and sprinklers.

In order to communicate between automation controllers and a network, a secure and trusted communication channel is needed. Conventional approaches have not provided secure and trusted communication channels between remotely located automation controllers and communication networks.

### BRIEF DESCRIPTION OF THE INVENTION

Embodiments of the present invention provide secure communications between automation controllers and communication networks. Since the communications are made over secure channels, a level of trust is established with automation controllers and various functions can be performed at the communication network and at the automation controllers due to this established trust.

In many of the embodiments, a secure communication channel is established between a communication network and a first automation controller. The first automation controller is located remotely from the communication network. First data is transmitted between the communication network and the first automation controller and/or second data is transmitted between the first automation controller and the communication network. Both transmissions utilize the secure communication channel. At the communication network, a function is automatically performed relating to the first automation controller using and in response to receiving the second data.

The second data that is transmitted from the first automation controller to the communication network may be the identity of the first automation controller, a location of the first automation controller, and an operating characteristic of the first automation controller. Other examples are possible. Data transmitted from the communication network to the first automation controller may be control logic. Other examples of data are possible.

The function performed may include a variety of functions. For example, the function performed may be determining a status of control logic disposed at the first automation controller, or establishing a local communication channel between the first automation controller and a second automation controller. Other examples of functions are possible.

In others of these embodiments, an apparatus that facilitates secure communications between an automation controller and a communication network includes a service interface and a controller. The service interface has an input and output.

The controller is coupled to the interface and is configured to establish a secure communication channel between a communication network and a first automation controller. The automation controller is located remotely from the communication network. The controller is further configured to transmit first data between the communication network and the first automation controller and/or second data between the first automation controller. The communication network utilizes the secure communication channel in making the communications. At the communication network, a function relating to the first automation controller using and in response to receiving the second data is automatically performed. Examples of such functions have been described above.

### BRIEF DESCRIPTION OF THE DRAWINGS

For a more complete understanding of the disclosure, reference should be made to the following detailed description and accompanying drawings wherein:

FIG. 1 comprises a block diagram showing a system that establishes and utilizes secure communication channels between automation controllers and communication networks according to various embodiments of the present invention;

FIG. 2 comprises a flowchart of establishing secure communications between a communication network and an automation controller according to various embodiments of the present invention;

FIG. 3 comprises a flowchart for performing a specific function at a communication network according to various embodiments of the present invention; and

FIG. 4 comprises a block diagram apparatus for establishing and utilizing secure communications between a communication network and an automation controller according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the approaches described herein, one or more secure communication channels are established between a communication network and one or more remotely located automation controllers. The establishment of a secure and trusted communication channel between the communication network and the automation controller(s) allows functions to be confidently performed at the communication network (because the automation controller is a known and trusted entity) and data can be passed securely between the automation controllers and the communication network.

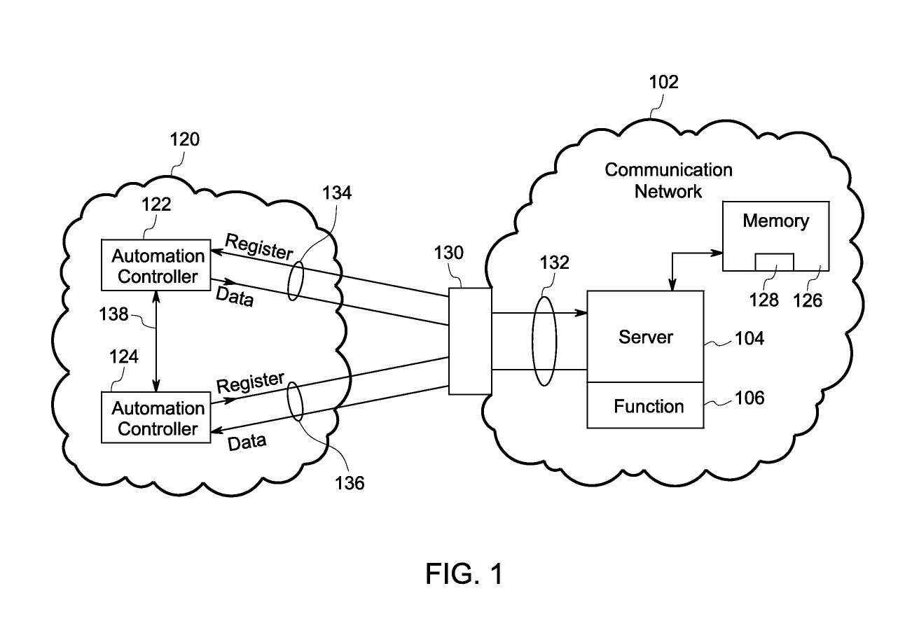

Referring now to FIG. 1, one example of a system for establishing and providing a secure communication channel between a communication network 102 and one or more automation controllers is described. The system includes a communication network 102. The communication network 102 is coupled to a customer site 120. The customer site 120 includes a first automation controller 122 and a second automation controller 124. The customer site 120 may be any factory, office, home, power plant, device, communication facility (e.g., a base station) or any other location that may advantageously use an automation controller.

The communication network 102 is any type of communication network such as the Internet, a computer network, a cellular telephone network, or any combination of these or other networks. In this respect, the communication network 102 may include any number of devices such as computers, access points, routers, and servers, to mention a few examples.

The communication network 102 includes a server 104 and a memory 126. The memory 126 (which can be any type of memory device or combination of memory devices) includes a control logic representation 128.

The control logic representation 128 is a description (in one example, implemented as programmed software or code) that represents the control logic at one or more of the automation controllers 122 or 124. More specifically, the control logic representation 128 describes the functions, workings, operation, inputs, outputs, and other characteristics of the operation of the associated control logic of the automation controller 122 or 124. In other aspects, the control logic representation 128 may be a solution of hardware, software, or combinations of hardware and software elements. In one aspect, the control logic representation 128 is the same as the control logic at the automation controller. Consequently, changes can be made to the control logic representation 128 (without halting the operation of the automation controller 122 or 124) and these can be later downloaded to the automation controller 122 or 124.

Automation controllers 122 or 124 may be any device, combination of devices, or network of devices that are implemented in any combination of hardware or software. In one example, the automation controller 122 or 124 is an assembly line controller. In other examples, the automation controller 122 or 124 is a controller for a pumping network (e.g., pumps, valves, pipes, sprinklers, and their associated controllers). Other examples of automation controllers and systems that utilize automation controllers are possible.

The server 106 includes a controller and in this respect is configured to receive registration information from the automation controllers 122 or 124, verify the registration information, and establish a secure communication channel with the automation controllers 122 or 124. The server 106 couples to a gateway 130 (via a first communication path or link 132), which in turn is coupled to the automation controllers 122 and 124 (via second and third communication paths or links 134 and 136). A fourth communication path or link 138 exists between the first automation controller 122 and the second automation controller 124. As shown, the various communication paths or links form a communication channel between the network 102 and the automation controllers 122 and 124. The communication paths may include, or carry registration information and requests as well as data. Registration information may include requests of a user at an automation controller to register at the network 102. Data includes any type of information that can be exchanged between the network 102 and the automation controllers 122 and 124. The gateway 130 may provide security and routing functions for communications as known to those skilled in the art.

In one example of the operation of the system of FIG. 1, a secure communication channel is established between the communication network 102 and the first automation controller 122. The first automation controller 122 is located remotely from the communication network 102. This secure channel may be established by having a user at the automation controller 122 register at the communication network 102. In this regard, the user may send a registration request via links 134 and 132. After the request is approved at the network 102, the network 102 (e.g., the server 106) knows, for instance, the identity of the user, the location of the user, and other relevant information about the user. The user at the automation controller 122 is now a trusted user and secure communications may now proceed over the channel that includes links 132 and 134. The registration process may follow a variety of known registration approaches or protocols that are known to those skilled in the art. It will be appreciated that as used herein, communication link, path, or channel may refer to both physical or logical links, paths, or channels.

First data is transmitted between the communication network 102 and the first automation controller 122, or second data is transmitted between the first automation controller 122 and the communication network 102 utilizing the secure communication channel. At the communication network 102, a function may be automatically performed relating to the first automation controller 122 using the second data.

The second data that is transmitted from the first automation controller 122 to the communication network 102 may be the identity of the first automation controller 122, a location of the first automation controller 122, and/or an operating characteristic of the first automation controller 122. Other examples of data are possible. The first data transmitted from the communication network 102 to the first automation controller 122 may be control logic 112. Other examples of data are possible.

The function performed by the server 106 may include a variety of different functions. For example, the function performed may be determining a status of control logic disposed at the first automation controller 122, or establishing a local communication channel between the first automation controller 122 and the second automation controller 124. Other examples of functions are possible and may be performed at the network 102 and/or the automation controllers 122 or 124.

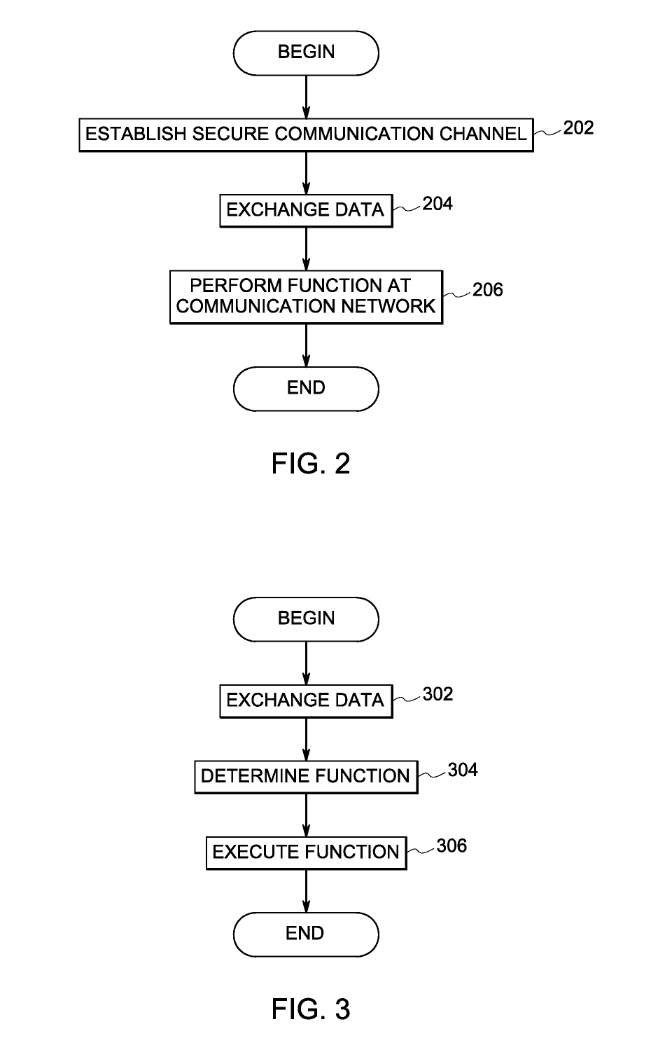

Referring now to FIG. 2, one example of an approach for establishing a secure connection between a network and an automation controller is described. At step 202, a secure communication channel is established between a communication network and an automation controller. The automation controller is located remotely from the communication network. This secure channel may be established by having a user at the automation controller register at the communication network. In this regard, the user may send a registration request to the communication network. After the request is approved at the network, the network (e.g., a server at the network) knows, for instance, the identity of the user, the location of the user, and other relevant information about the user. After registration is complete, the user at the automation controller is now a trusted user and secure communications may proceed over the secure communication channel. The registration process may follow a variety of known registration approaches or protocols that are known to those skilled in the art.

At step 204, data is exchanged between the automation controller and the communication network. For example, data is transmitted from the communication network to the automation controller, for instance, control logic. In another example, data is transmitted from the automation controller to the communication network, for instance, parameter information.

At step 206 and at the communication network, a function may be automatically performed relating to the automation controller using and in response to receiving the data.

Referring now to FIG. 3, one example of an approach for performing a function at the communication network is described. At step 302, data is exchanged between the communication network and one or more automation controllers. In one example, first data (e.g., control logic) is transmitted from the communication network to the first automation controller, and second data (e.g., operational data) is transmitted from the first automation controller to the communication network utilizing the secure communication channel.

At step 304 and at the communication network, an automatic determination is made of a function to be performed. Various considerations may be used to determine the function including, but not limited to, the content of the second data (e.g., received from the automation controller) or other information (e.g., indicating the desirability of having two automation controllers communicate directly with each other without using the communication network).

At step 306, the function is performed. The function performed may include a variety of different functions. For example, the function performed may be determining a status of control logic disposed at the first automation controller, or establishing a local communication channel between a first automation controller and a second automation controller. Other examples of functions are possible.

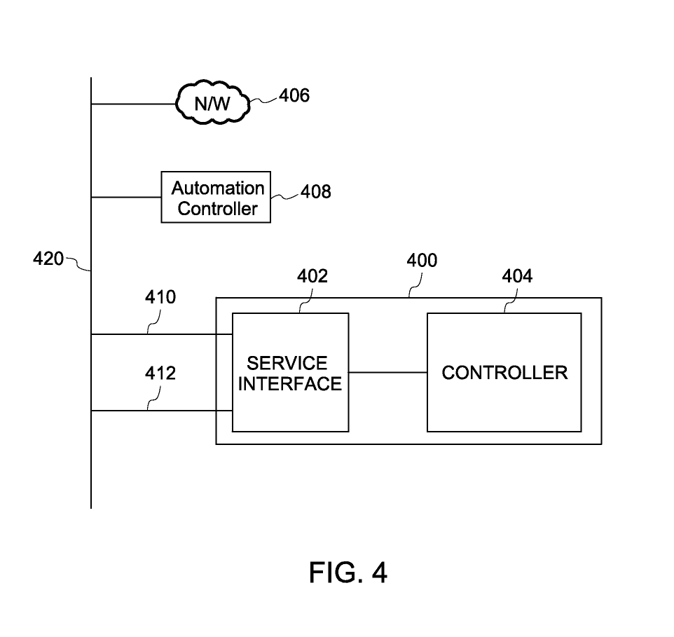

Referring now to FIG. 4, one example of an apparatus 400 that facilitates secure communications between an automation controller 408 and a communication network 406 includes a service interface 402 and a controller 404. The service interface 402 has an input 410 and output 412. The apparatus 400 may be deployed at the communication network and/or a gateway (e.g., gateway 130 of FIG. 1).

The controller 404 is coupled to the interface 402 and is configured to establish a secure communication channel between the communication network 406 and an automation controller 408. The automation controller 408 is located remotely from the communication network 406. The controller 408 is further configured to transmit first data between the communication network 406 and the automation controller 408 and/or receive second data from the first automation controller 408. The communication network 406 utilizes the secure communication channel 420 in making the communications. At the communication network 406, a function relating to the automation controller 408 is performed. The function is performed in response to receiving the second data. Examples of functions are described elsewhere herein. The apparatus 400 may be deployed within the communication network 406, for example, at a server within the network. Other deployments are possible.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of providing secure communications between an automation controller and a communication network, the method comprising:
establishing a secure communication channel between a communication network and a first automation controller, the first automation controller being located remotely from the communication network;
transmitting first data between the communication network and the first automation controller or second data between the first automation controller and the communication network utilizing the secure communication channel; and
at the communication network, automatically performing a function relating to the first automation controller using and in response to receiving the second data.

2. The method of claim 1, wherein the second data transmitted from the first automation controller to the communication network comprises at least one of an identity of the first automation controller, a location of the first automation controller, and an operating characteristic of the first automation controller.

3. The method of claim 1, wherein the first data transmitted from the communication network to the first automation controller comprises control logic.

4. The method of claim 1, wherein performing the function comprises determining a status of control logic disposed at the first automation controller.

5. The method of claim 1, wherein performing the function relating to the first automation controller comprises establishing a local communication channel between the first automation controller and a second automation controller, the second automation controller being located remotely from the communication network.

6. The method of claim 1, wherein the communication network comprises a server.

7. An apparatus providing secure communications between an automation controller and a communication network, the apparatus comprising:
a service interface having an input and output;
a controller coupled to the interface, the controller configured to establish a secure communication channel between a communication network and a first automation controller, the first automation controller being located remotely from the communication network, the controller further configured to transmit first data between the communication network and the first automation controller or second data between the first automation controller and the communication network utilizing the secure communication channel; and
wherein, at the communication network, a function relating to the first automation controller using and in response to receiving the second data is automatically performed.

8. The apparatus of claim 7, wherein the second data transmitted from the first automation controller to the communication network comprises at least one of an identity of the first automation controller, a location of the first automation controller, and an operating characteristic of the first automation controller.

9. The apparatus of claim 7, wherein the first data transmitted from the communication network to the first automation controller comprises control logic.

10. The apparatus of claim 7, wherein the function performed comprises determining a status of control logic disposed at the first automation controller.

11. The apparatus of claim 7, wherein the function performed relates to the first automation controller comprises establishing a local communication channel between the first automation controller and a second automation controller, the second automation controller being located remotely from the communication network.

12. The apparatus of claim 7, wherein the communication network comprises a server.
